(19) United States
(12) Patent Application Publication
(10) Pub. No.: US 2024/0366055 A1
(43) Pub. Date: Nov. 7, 2024

(54) CLEANING SET

(71) Applicant: Fugenial GmbH, Zeulenroda-Triebes (DE)

(72) Inventor: André WALDENBURGER, Zeulenroda-Triebes (DE)

(73) Assignee: Fugenial GmbH, Zeulenroda-Triebes (DE)

(21) Appl. No.: 18/429,972

(22) Filed: Feb. 1, 2024

(30) Foreign Application Priority Data
May 5, 2023 (DE) 102023111847.1
May 5, 2023 (DE) 202023102462.9
May 5, 2023 (EP) 23171965.9

(51) Int. Cl. A47L 13/255; A47L 13/44

(52) U.S. Cl. CPC A47L 13/255; A47L 13/44

(57) ABSTRACT

The invention concerns a cleaning set (1) for cleaning a surface, preferably for cleaning a floor, comprising at least a base plate (10) with an upper side (11), on which a coupling point (12) for a shaft (60) is arranged, and with an underside (21) facing away from the upper side (11), wherein the base plate (10) has a diamond-shaped contour (10g), and a textile mop cover (40) with a diamond-shaped textile base surface (40g) which is adapted to the diamond-shaped contour (10g) of the base plate (10) and/or a further cleaning attachment (70) which can be coupled to the underside (21) of the base plate (10). On the underside (21), the base plate (10) comprises at least one adhesive element (22), preferably a hook-and-loop element (22), and preferably the textile mop cover (40) comprises at least one matching mating adhesive element (42), preferably a mating hook-and-loop element (42), on an upper side (41). Alternatively or additionally, the textile mop cover (40) has an insertion loop and/or insertion pocket (43) for a first acute-angled corner region (10a) of the base plate (10) on at least a first acute-angled corner region (40a) of the diamond-shaped textile base surface (40g) on an upper side (41) and also has a first quick-release fastener element (45, 45l, 45s) or a second insertion pocket (43) for releasable coupling to the base plate (10) on at least one second corner region (40b, 40c, 40d), preferably a second acute-angled corner region (40b), of the diamond-shaped textile base surface (40g), which is preferably opposite the first acute-angled corner region (40a) of the textile base surface (40g) . . . . Again alternatively or additionally, the base plate (10) is associated with a retaining plate (75) which can be releasably coupled to the underside (21), wherein the retaining plate (75) has at least one retaining element (79) for releasably coupling the textile mop cover (40).

The invention relates to a cleaning set for cleaning a surface, preferably for cleaning a floor, comprising at least one base plate with an upper side, on which a coupling point for a shaft is arranged, and an underside facing away from the upper side, wherein the base plate has a diamond-shaped contour, and at least one textile mop cover.

Cleaning sets with a mop, base plate and possibly a shaft are everyday objects that are used and utilised for cleaning purposes both privately and commercially. The mop in the cleaning set is used for (often wet) cleaning of smooth floors. There are already plenty of cleaning sets designed for private use, e.g. with a bucket and mechanism for washing and wringing out the mop. Although these cleaning sets are frequently used, they are unsuitable from a hygiene point of view, at least in buildings such as hospitals, old people's homes, etc., as the mop does not really get clean when it is washed out and mopping is carried out with dirty water for long periods of time. On the one hand, the conditions in such buildings are usually completely different, i.e. there is usually a greater and more complex degree of soiling. In addition, the areas are usually larger and there is less time available, or the labour force is given less time. On the other hand, unfortunately, the focus in the commercial environment is perforce more on quantity than on quality. Unfortunately, this is also due to the way in which staff are usually paid, namely by the area which has been cleaned. In this case, the workers themselves are primarily interested in needing as little time as possible for as big a work area as possible. If the staff are paid on an hourly basis, the employer is primarily interested in ensuring that the cleaning process runs as quickly as possible so that as big an area as possible can be cleaned in as little time as possible. Notwithstanding this, in any case there is an interest in providing a cleaning set that minimises the time needed to change the mop between actual cleaning periods. This is because the actual cleaning time required to clean an area can only be reduced to a certain extent (otherwise the quality suffers enormously).

Nowadays, in commercial cleaning, e.g. cleaning hospital floors etc. (provided that the cleaning is carried out professionally), for reasons of hygiene, the mop or a textile mop cover is usually immediately replaced with a fresh textile mop cover after being used once. Only then are the collected, used textile mop covers usually effectively cleaned together in a cleaning system, e.g. in a hot wash in a washing machine, and, if necessary, by disinfecting them. This procedure has proven to be far more hygienic than having the textile mop covers washed out several times in between by the cleaning staff themselves and then continuing to use them.

This is why the standard cleaning sets with a bucket for rinsing and a mechanism for wringing out are generally not suitable for commercial cleaning. In most cases, either changing the mop is time-consuming due to the design, as the mop does not actually need to be detached from the holder for washing and wringing, or the mop is in fact securely attached to the holder.

It is therefore an objective of the present invention to provide a cleaning set which enables particularly rapid and uncomplicated changing of the textile mop cover, or possibly another cleaning attachment, in particular with only one hand in one movement.

This objective is achieved by a cleaning set according to patent claim 1.

As mentioned at the beginning, the cleaning set for cleaning a surface, preferably for cleaning a floor, comprises at least one base plate with an upper side on which a coupling point for a shaft is arranged. “Cleaning” or “clean” should also be understood here to mean disinfecting, wiping, dry wiping or, for example, the application of a liquid such as a cleaning liquid, e.g., to a surface.

It should also be noted at this point that although the cleaning set is always described below in relation to cleaning a floor, it can also be used to clean a wall, table or ceiling surface, for example.

The base plate also has an underside facing away from the upper side. The base plate here has a diamond-shaped contour. The diamond-shaped contour comprises a closed contour, i.e. no indentations or the like. The diamond-shaped contour is preferably a rhombus with two acute and two obtuse internal angles, i.e. two acute-angled corner regions and two obtuse-angled corner regions.

The two acute-angled corner regions preferably lie opposite each other at the ends of a longer first diagonal (also known as the “long diagonal”) of the rhombus and the obtuse-angled corner regions lie opposite each other at the ends of a shorter diagonal (also known as a “short diagonal”) that runs transversely, preferably at right angles, to the first diagonal. Preferably, the base plate is mirror-symmetrical in relation to both diagonals.

Preferably, the internal angles of the acute-angled corner regions of the base plate can be a maximum of 30°. This extends the edge length of the base plate slightly compared to a standard square base plate, so that a user can always reach into the corners when cleaning floors in rooms or the corner steps of spiral staircases. This means that the edges of the base plate run together into a point in this acute-angled corner region and the tip formed as a result is not rounded (apart from a minimal rounding angle, which may be unavoidably dictated by production tolerances but is negligible with regard to the desired function for cleaning corners). In this regard, this acute-angled diamond-shaped contour preferably concerns both the base plate itself and the textile mop cover as well as all accessories or cleaning attachments, which will be explained further below.

As already mentioned, the cleaning set also includes a textile mop cover with a diamond-shaped textile base for picking up dirt on the floor. The diamond-shaped textile base surface is adapted to the diamond-shaped contour of the base plate. This means that it is almost the same size and may be slightly larger so that it can be at least partially placed or slipped over the base plate.

Accordingly, the internal angles of the acute-angled corner regions of the textile base surface can also preferably be at most 30°. The tapered or acute-angled corner regions ensure that the base plate and the textile mop cover do not completely fill a right-angled corner during cleaning. Completely filling a corner during cleaning would be unfavourable in practical use, as a dynamic wiping movement would then no longer be possible. Because a rhombus has this acute angle on two sides, it is possible to switch quickly between the sides so that both sides can be used for cleaning and in this way, for example, two such corners can be cleaned very dynamically one after the other.

In the simplest case, the textile mop cover is a cleaning textile or cloth with fringes or loops. The cleaning textile can have any number of short or long fringes or loops to pick up dust on the floor. It can also be moistened or used really wet for more effective floor cleaning. Accordingly, it is also known as a textile mop cover or wiping cloth.

As an alternative or in addition to the textile mop cover, the cleaning set includes a further cleaning attachment that can be attached to the underside of the base plate. Details will be described later.

To ensure that the textile mop cover always remains on the base plate during use, in this regard, the base plate preferably comprises at least one adhesive element on the underside. This adhesive element can preferably be a hook-and-loop element, i.e. usually a hook strip, to which the textile mop cover then adheres. More preferably, the adhesive element, e.g. when the base plate is manufactured in an injection moulding process, is also injection moulded, e.g. in the form of (small) hooks, spikes etc. The material of the textile mop cover can then be selected accordingly, which is suitable in most cases anyway, or, for example, an additional fleece strip can be sewn in as a mating hook-and-loop element, as explained below.

Preferably, the textile mop cover can have a mating adhesive element which is complementary to the adhesive element, in particular a mating hook-and-loop element, which is at least partially, preferably completely, integrated into the textile mop cover (in the upper side). Preferably, the mating hook-and-loop element can be woven into the textile mop cover. The mating adhesive element, in particular the mating hook-and-loop element, can also be made in several parts.

Preferably, the textile mop cover can therefore comprise at least one matching mating adhesive element on an upper side. Accordingly, this can particularly preferably be a mating hook-and-loop element, i.e. if the hook-and-loop element is a hook strip, it is a loop strip, and vice versa. The upper side here refers to the inner side facing the base plate during the intended use or application, which then rests against the underside of the base plate.

The textile mop cover can also, for example, preferably have such a mating adhesive element, in particular a mating hook-and-loop element, over its entire surface or at least substantially over its entire surface, for example except for a (narrow) edge region, or be configured as such a mating adhesive element, in particular a mating hook-and-loop element, on the upper side. The dimensions of the adhesive element, in particular the hook-and-loop element, on the underside of the base plate can preferably be selected to match this.

Alternatively or additionally, the textile mop cover can have an insertion loop and/or insertion pocket for a first acute-angled corner region of the base plate on at least one first acute-angled corner region of the diamond-shaped textile base surface on an upper side, in particular for receiving the corner region. This means that the textile mop cover can be sewn there, for example in the form of a textile insertion loop and/or insertion pocket.

Furthermore, the textile mop cover can have a first quick-release fastener element or a second insertion pocket for releasable coupling to the base plate at at least a second corner region of the diamond-shaped textile base surface. Preferably, the releasable coupling to the base plate takes place at a second acute-angled corner region of the base plate.

Preferably, the textile mop cover can have a first quick-release fastener element or a second insertion pocket for releasable coupling to the base plate at a second acute-angled corner region of the textile base surface which is opposite the first acute-angled corner region of the textile base surface.

Preferably, the base plate can have a mating coupling element for the quick-release fastener element at a second acute-angled corner region. This construction has the advantage that the quick-release fastener element is also then held particularly securely on the base plate even if the base plate is frequently lifted from the floor, e.g. to clean or scrub steps or the like.

When cleaning a standard flat floor, however, during cleaning, the cleaning set can also generally be used without such a special mating coupling element for the quick-release fastener element. This is because the base plate usually only needs to be lifted to attach and change the textile mop cover. Therefore, in this case it may be sufficient to simply loop the quick-release fastener element, for example if it is configured as an elongated piece of material, namely a strip, cord, string or the like (as will be explained in more detail below), once or several times around the relevant acute-angled corner region of the base plate for somewhat faster (but not completely secure) attachment to the base plate, so that the textile mop cover remains securely on the base plate in its intended cleaning position, at least when in contact with the floor or only lifted slightly.

The two acute-angled corner regions, i.e. the first acute-angled corner region and the second acute-angled corner region, are the two corner regions of the four corner regions of the diamond-shaped textile base surface, for which the internal angles between the contour edges or sides are each smaller than in the two remaining corner regions. “Acute-angled” also means that the diamond-shaped base surface has two acute internal angles there and correspondingly obtuse internal angles in the two remaining corner regions. Preferred values for the acute internal angles will be mentioned later for a preferred embodiment of the invention.

Alternatively or additionally, the base plate can be associated with a retaining plate which can be releasably coupled to the underside of the base plate. In this regard, the retaining plate (e.g. only a few millimetres thick) has at least one retaining element for releasably coupling the textile mop cover to the retaining plate. The retaining element is more preferably arranged on an underside of the holding plate, which—in the coupled state of the retaining plate on the base plate—is directed away from the base plate. Most preferably, the retaining element can also be at least partially, in particular completely, integrated into the retaining plate. As an example, the retaining element can be integrated into the underside of the retaining plate. Preferably, the retaining element can be co-injected during the production of the retaining plate in an injection moulding process. As an example, small hooks, spikes or the like can be co-injected or formed, which then also secure the textile mop cover against slipping when cleaning the surface.

Irrespective of the specific embodiment, the retaining element can also be configured in several parts.

The construction according to the invention ensures the necessary adhesion, e.g. relative static friction between the base plate and the textile mop cover. As a result, the textile mop cover is retained particularly well in the intended position on the base plate during the cleaning process, e.g. during dynamic movements on the floor surface, when lifting perpendicular to it, e.g. when the textile mop cover has to be lifted over a threshold in order to clean the next room or further steps or, e.g., when contamination on the floor, such as a sticky spot, causes increased friction.

On the other hand, the textile mop cover can also be attached to the base plate very easily and quickly and removed again just as quickly and easily for changing.

The cleaning set according to the invention thus represents a particularly simple and quick-change cleaning set, which is ideally suited for commercial use. It thus enables time to be saved when cleaning floors, which results from the particularly quick and easy changeability of the textile mop cover, and possibly another cleaning attachment. Where time is lost when changing the textile mop cover in known constructions, time can be saved with the construction according to the invention, which in turn is then available for cleaning other floor surfaces.

Furthermore, the diamond-shaped contour with acute-angled corner regions also helps to effectively clean tight corners on the floor right into the most remote part of the corner. Furthermore, the diamond-shaped contour with acute-angled corner regions helps to clean narrow areas, e.g. between chair or table limbs, etc. with ease, without bumping into them, as the acute-angled corner region can be threaded into the narrow gap or guided along the object in question without impacting on a wide side (e.g. with rectangular or square base plates).

If the cleaning set is configured with mutually corresponding adhesive elements as described above, the textile mop cover can be attached to the base plate particularly quickly and easily, substantially with just one hand in one swift movement. This saves a lot of time, additional handling and is also much more hygienic. Even if the textile mop cover is attached to the base plate via an insertion pocket and, for example, a quick-release fastener element or by means of a retaining plate, the textile mop cover can be changed quickly and easily. The invention is therefore particularly suitable in the field of commercial cleaning, as time is of paramount importance here and saving time means saving costs.

Furthermore, the construction according to the invention, in particular the base plate with textile mop cover, can have such a low structural height that, as far as possible, only the surface to be cleaned itself is cleaned or wetted, but not a bounding surface such as an adjacent wall surface or an ancillary part of the building. This is advantageous, for example, when applying a coating or sealant, e.g. with cleaning agents, polymer coatings etc., In practical terms, this means that no neighbouring bounding surfaces need to be masked off when applying a cleaning agent or polymer coatings, etc.

Further, particularly advantageous embodiments and further embodiments of the invention are defined in the dependent claims and the description below, wherein the independent claims of one category of claims can also be further refined analogously to the dependent claims and embodiments of another category of claims and in particular, individual features of different exemplary embodiments or variations can also be combined to form new exemplary embodiments or variations.

There are various options for anchoring or relative attachment between the base plate and the textile mop cover:

Preferably, the first quick-release fastener element may comprise a flexible, elongated piece of material, such as a strip, a cord, a string or a tab, preferably a textile tab.

Preferably, the base plate may have anchoring means on its upper side, preferably as a mating coupling element, for the flexible, elongated piece of material. The term “anchoring means” as used here is intended to encompass all means which can be used for anchoring. These can more preferably be arranged in the corresponding second corner region of the base plate associated with the second corner region of the textile base surface, in particular during (cleaning) operations.

Preferably, the base plate can comprise a cleat on its upper side as an anchoring means for the flexible, elongated piece of material. This can preferably again be arranged in the corresponding second corner region of the base plate associated with the second corner region of the textile base surface.

More preferably, the base plate can even include two fastening pins or “fastening nipples” as anchoring means for the piece of material. These can, for example, protrude slightly upwards or away from the base plate, so that a user can very easily and quickly secure the flexible, elongated piece of material to it, fix it in place or anchor it around it.

However, it is also possible that, instead of two physically separated fastening pins, only fastening pins which are at least diagonally spaced apart or diverge from each other or are spaced apart from each other in at least one anchoring area are used. This allows the flexible, elongated piece of material for anchoring to still be easily tied or placed around the “individual” fastening pins.

For simple and quick, but at the same time sufficiently secure anchoring to a cleat or two such fastening pins, what is known as a “Dopino” knot, i.e. a slip knot at the beginning with a half hitch at the end (the other way round to a normal cleat hitch), is ideal. Such a knot can be tied and untied very quickly in a very simple but effective way.

Alternatively or additionally, for example, the fastening pins can also be configured to be slip-resistant, for example with an anti-slip coating, or their outer shape can ensure that, for example, an elongated, flexible piece of material slips as little as possible on them or does not slip off them when it is wrapped around them.

Preferably, the first quick-release fastener element can comprise a tab. In other words, it can therefore be of a band-like design, preferably sufficiently wide so that when the tab is pulled upwards over a tip of the relevant acute-angled corner region of the base plate, the tab envelops the tip. The tab can preferably be a textile tab or tab produced from a textile. This ensures a certain flexibility and facilitates attachment, e.g. by sewing.

Preferably, the tab can have a hook-and-loop tab for a mating hook-and-loop element arranged on the upper side of the base plate.

More preferably, the mating hook-and-loop element, e.g. a hook strip, can be arranged on the upper side in the region of the second acute-angled corner region of the base plate. This serves to attach the hook-and-loop strip, which in this case could be a loop strip that adheres to the hook strip.

Preferably, the first quick-release fastener element can comprise an elastically extendable loop which can be slipped or pulled over at least one acute-angled corner region of the base plate for fastening to the base plate. The loop, e.g. an elastic band or a rubber band or the like, can, e.g., in turn be sewn onto the associated acute-angled corner region of the textile mop cover in an area slightly spaced from the tip, i.e. not at the very front of the tip, i.e. slightly further inwards parallel to the short diagonal of the textile mop cover.

Preferably, the loop, in particular also the respective insertion pocket, is arranged on an upper side of the textile mop cover, in particular the textile base surface, which is opposite a cleaning surface (as the underside) of the textile mop cover.

Preferably, the textile mop cover can be provided with an insertion strip on a side half or half that has the insertion loop and/or insertion pocket, which internally connects the two contour edges connected by the insertion loop and/or insertion pocket in the acute-angled corner region of the diamond-shaped textile base surface at a position between the insertion loop and/or insertion pocket and the short diagonal of the diamond-shaped textile base surface. The insertion strip is preferably arranged on the upper side of the textile mop cover or spans the upper side of the textile base surface. The insertion strip therefore bridges the textile base surface and thus forms a holding loop for threading the textile mop cover relative to the base plate.

Preferably, the insertion strip can extend perpendicular to a longitudinal direction of the textile mop cover, i.e. parallel to the short diagonal of the textile mop cover. The short diagonal is the shorter of the two diagonals, in this case the diamond-shaped textile base surface. A position approximately centred between the tip of the relevant acute-angled corner region and the short diagonal is more preferred, and most preferably closer to the short diagonal or the diagonal intersection point than to the tip.

There are various options for further equipping the cleaning set.

Preferably, the further cleaning attachment mentioned above can be releasably coupled to the base plate by means of at least one second quick-release fastener element.

Alternatively or additionally, the retaining plate can be releasably coupled to the base plate by means of at least one second quick-release fastener element.

The cleaning attachment and/or the retaining plate can preferably have a plate-like, diamond-shaped base surface, which is adapted to the diamond-shaped contour of the base plate.

Preferably, the further cleaning attachment can comprise at least one of the following elements, namely a brush plate, a sponge element or a pad plate. Preferably, the further cleaning attachment can be releasably coupled to the base plate as an alternative to a textile mop cover in order to form a (ready-to-use) cleaning set above it.

A brush plate or bristle plate refers to a plate with brushes or bristles that can be used to clean stubborn, coarse dirt on the floor. A sponge element refers to a plate or cube-shaped cleaning attachment comprising a sponge which can be used, for example, to absorb moisture or for moistening more sensitive floors. However, the sponge can also be a glass ceramic sponge for removing grease and stubborn dirt, such as burnt-on dirt.

A pad plate here refers to a pad-such as a scrubbing pad, a microfibre pad, a hand pad, a polishing pad or similar-which is arranged on a plate.

There are preferred options for attaching such a cleaning attachment and/or the retaining plate to the base plate.

Preferably, the second quick-release fastener element on the base plate can have at least one through-hole passing through the base plate. “Continuous” here means completely through the base plate from the upper side to the underside.

Furthermore, the second quick-release fastener element can comprise at least one coupling element in order to couple the additional cleaning attachment and/or the retaining plate to the underside of the base plate through the through-hole.

It is particularly preferable for the base plate to have two through-holes passing through the base plate in order to be able to couple the additional cleaning attachment and/or the retaining plate at two positions evenly distributed over the base plate. For coupling, for example, the principle of a clamping closure with a cap lifter (as used to close glass bottles) could be used.

In a preferred variation, the coupling element can be configured as a screw element, i.e. as a wing screw or threaded rod with wing nut. Preferably, to this end, the cleaning attachment and/or the retaining plate can also be configured with corresponding internal threaded holes.

In a particularly preferred variation, the cleaning set comprises two wing screws, a base plate with two, preferably four, through-holes for variable attachment of the two wing screws and the additional cleaning attachment and/or the retaining plate, two threaded holes for screwing in the wing screws.

Preferably, the retaining element of the retaining plate can have an adhesive element, in particular a hook-and-loop element. The adhesive element, in particular a hook-and-loop element, may, e.g., be in the form of a plate or film, e.g. only a few millimetres thick, in order in particular to attach the textile mop cover to it and hold it in the attached position when cleaning the floor.

Alternatively or additionally, at least 30%, preferably at least 50%, more preferably at least 75%, of an underside of a base surface of the retaining plate can have a retaining element. In principle, the underside of the retaining plate can also be configured substantially entirely as a retaining element, in particular as an adhesive element. Accordingly, the textile mop cover then adheres at least partially to the retaining plate, wherein it adheres over the entire surface wherever there is an adhesive element. For this purpose, in the coupled state, the adhesive element can, for example, have a surface facing the textile mop cover with a hook surface with a plurality of hooks or barbs. These then hold the material of the textile mop cover firmly in place, for example, after lightly pressing on it, wherein a certain position is maintained between the retaining plate and the textile mop cover, particularly during (cleaning) operations. To change the textile mop cover, it can then be pulled off or detached from the adhesive element, e.g. in a rolling movement along the retaining plate, simply by using a slight pulling force, e.g. in the same way as a hook-and-loop strip, an adhesive tape or film is pulled off a hook-and-loop or adhesive surface. Advantageously, this allows for easy removal/installation of the textile mop cover, wherein a secure, temporary attachment of the textile mop cover to the base plate (via the retaining plate) is achieved.

If the retaining plate is manufactured using an injection moulding process, as is preferred, it is also possible to integrate the retaining element into the retaining plate, more precisely on the underside of the retaining plate, i.e. to form or injection-mould it. As an example, a hook surface with a plurality of hooks can also be integrated into the underside of the retaining plate.

As mentioned above, there is a coupling point for a shaft in the upper side of the base plate, i.e. any element that enables the base plate to be coupled to a shaft. In principle, this coupling point can be of any design, provided that a corresponding mating coupling element, e.g. a suitable adapter, is arranged at the (lower) end of the shaft that is to be coupled to the base plate.

As an example, in a preferred variation, a hand grip can also be arranged on the upper side of the base plate. This can be particularly advantageous when used for cleaning a wall, table or ceiling surface. Preferably, such a hand grip can have at least one hand grip opening and/or at least one recessed grip. As an example, the hand grip can extend in an arc (so that the hand grip opening remains below the arc) in a longitudinal direction, which preferably runs parallel to one of the diagonals above the base plate, more preferably parallel to the longer diagonal.

As an example, the hand grip itself can serve as a coupling point for a shaft if it has a suitable mounting element or adapter (for example, a clamping device for clamping the handle). In particular, however, the hand grip can also be configured in a manner such that it has a coupling element specially provided for this purpose, for example a coupling eyelet (a coupling hole or a coupling bore) into which, for example, an axle or at least a stub axle or a pin on a mating coupling element or adapter at the end of a shaft can be inserted.

Such a coupling eyelet can preferably be arranged in a manner such that a (virtual) coupling axis through the coupling eyelet, along which, for example, an axle or the said stub axles or pins on an adapter at the end of a shaft can be inserted, runs transversely to the hand grip, more preferably perpendicular to a longitudinal extension of the handle and parallel above the upper side of the base surface. An example of a suitable adapter for coupling a shaft with such a coupling eyelet is described, for example, in DE 10 2019 113 870 A1. At a lower end, this has a U-shaped, fork-like holder with two fork arms, from which two short pins or stub axles lying opposite each other extend inwards into the space between the forks on a common (virtual) axis. This fork holder is made of a material (specifically plastic there) that allows the fork limbs to be easily pushed apart so that they clamp the handle between them on the upper side of the base plate, wherein the pins or stub axles engage in the coupling eyelet on the handle from both sides. This holds the handle securely on the adapter, which can still be swivelled around the virtual axis of the coupling eyelet. The upper part of the adapter can also be configured as in DE 10 2019 113 870 A1, for example, in order to be fitted into different shaft diameters.

Preferably, the cleaning set can comprise a coupling mechanism arranged at the coupling point of the base plate, which connects the base plate to the shaft. More preferably, the coupling point can be located (when viewed in a projection from above onto the upper side of the base plate) at the intersection of the diagonals of the diamond-shaped contour.

In this regard, the coupling mechanism can be configured in a manner such that the shaft can be swivelled relative to the base plate with at least two degrees of freedom. As an example, this is an at least two-axis joint or double joint or a ball joint.

More preferably, the cleaning set can comprise a fork joint, a joint block which is rotatable in the fork joint about a fork joint axis with fork joint mounting holes in at least two of its lateral surfaces and an adapter with an interface for a shaft which can be coupled to the joint block with a further fork joint. The adapter can be rotated in the additional fork joint about a second fork joint axis. This allows the shaft or the base plate, e.g. with the textile mop cover, to be positioned almost anywhere with respect to the shaft and with two degrees of freedom.

Preferably, the cleaning set can comprise a generally elongated shaft as a handle and extension for conveniently holding and guiding the cleaning set by a user and an adapter for attaching the base plate to the handle with an adapter element. The adapter element preferably has a tapered fitting section for forming a positive locking fit with one end of the handle and a tapered threaded section.

With such an adapter element of the adapter, different standard sticks or shafts can be attached to the adapter on the base plate and used.

If an adapter which is to be coupled to a coupling eyelet of a handle described above, which allows the base plate to be swivelled with several degrees of freedom with respect to the shaft is to be used for coupling to the handle, this adapter can of course also have a corresponding coupling mechanism, for example by using a joint block between the upper part and the lower part of the adapter of DE 10 2019 113 870 A1, similar to that described above.

In order to obtain coupling of the shaft with a handle on the upper side of the base plate that can be swivelled about two (swivel) axes, in another preferred variation of the handle, the handle itself can also have at least one part which can be swivelled, i.e. a swivel axis can be integrated into the handle, so to speak.

As an example, the handle could have a simple coupling eyelet extending transversely to the handle with which, for example, a U-shaped, fork-like holder (as in DE 10 2019 113 870 A1) of an adapter can be coupled to the end of a shaft as described above. This coupling then allows the shaft to be swivelled on the handle about a first swivel axis, namely the longitudinal axis through the eyelet. In order to allow the shaft to be swivelled relative to the base plate about a second swivel axis, which is transverse, preferably perpendicular, to this first axis, the handle can be configured in several parts. One part, which contains the coupling eyelet, can be arranged on the other parts of the handle so that it can be swivelled relative to them.

More preferably, an arcuate hand grip can be divided into at least three sections along its longitudinal extent, wherein the coupling eyelet is located in the centre section. This centre section is then pivotably coupled to the two outer sections of the handle about a swivel axis extending in the direction of the longitudinal extension of the handle (which then forms the second swivel axis), which in turn are each firmly connected to the upper side of the base plate. It is also preferably possible for the centre section of the hand grip to be lockable between the two outer sections of the handle in a basic position in which the axis runs through the coupling eyelet parallel to the top of the base plate, for example by means of suitable latching means. It can be swivelled (again) out of this basic position with slightly increased force and/or by actuating an integrated release device (e.g. pressure on a latching spring or similar).

Preferably, the underside of the base plate can be configured to be substantially flat over the entire contour, i.e. the entire length of the contour.

Because the base plate lies flat against the floor on the side facing the floor (at least indirectly via the textile mop cover) during its intended use, the base plate can be used to exert even pressure on the floor over the entire edge length of the contour edges during cleaning. This significantly improves the cleaning result.

In particular, pressure can thus also be exerted effectively in the area of the acute-angled corners of the diamond-shaped base plate.

Preferably, the base plate can comprise a diamond-shaped outer frame all round, between which an inner lattice structure with lattice struts, which economises on material, extends or is formed for stabilisation and reinforcement.

This economises on material and weight compared with a base plate made of solid material. However, the necessary reinforcement or stabilisation can still be achieved because of the lattice structure.

Preferably, the lattice structure can be configured in a manner such that the lattice struts converge in a star shape at three positions on one of the diagonals.

At a central position of the three positions, they can form an overlapping, merging central surface at which the coupling point for a shaft is located. At the two off-centre positions, they can each form an overlapping, merging attachment surface into which the through-holes are drilled.

Preferably, at least the inclined lattice struts of the lattice structure can each protrude from the frame or outer frame at the same angle, so that a uniform honeycomb structure is created overall.

More preferably, the lattice struts are hollow on the inside in order to economise even further on material and weight.

It should be noted at this point that a combination of the embodiments described above is also possible. As an example, a single base plate can be configured so that either a further cleaning attachment or a textile mop cover can be detachably attached to it. Preferably, depending on the configuration, a textile mop cover can be releasably attached to the same base plate either via an adhesive element of the base plate and/or via an insertion pocket and a first quick-release fastener element or via a retaining plate on the base plate.

The invention will now be explained in more detail below with reference to the accompanying figures with the aid of exemplary embodiments. In the various figures, identical components are provided with identical reference symbols. The figures are generally not to scale. In the figures

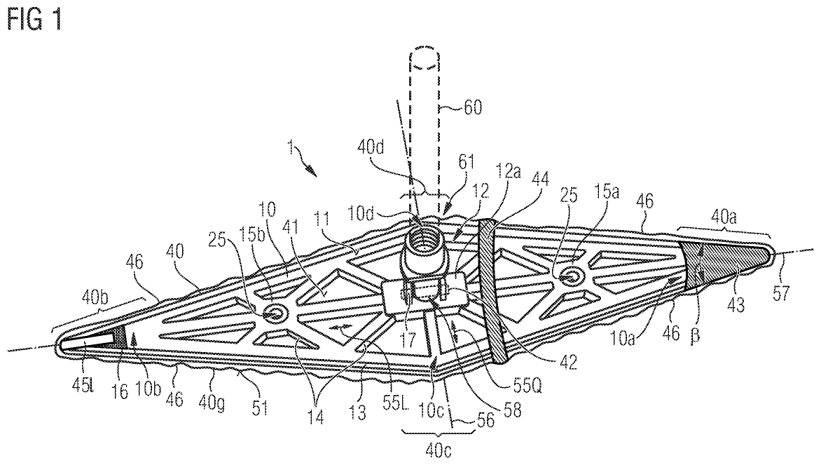

FIG. 1 is a perspective view of an exemplary embodiment of a cleaning set according to the invention with a textile mop cover and shaft coupled to the base plate,

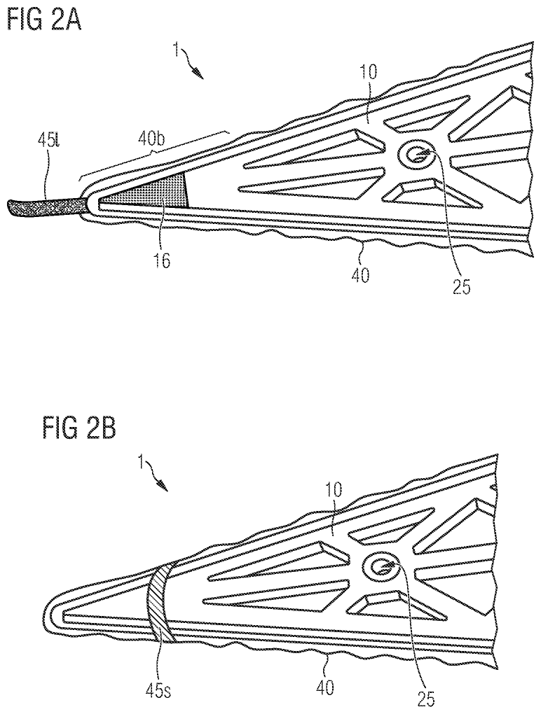

FIG. 2A is a perspective view of a section of the second acute-angled corner region of FIG. 1 with hook strip (on the base plate) and (just opened) hook-and-loop tab as the first quick-release fastener element,

FIG. 2B is a perspective view of part of an exemplary embodiment of a cleaning set according to the invention, but this time with a loop as the first quick-release fastener element,

FIG. 2C is a perspective view of part of an exemplary embodiment of a cleaning set according to the invention, this time with a cleat (on the base plate) and a flexible, elongated piece of material as the first quick-release fastener element,

FIG. 2D is a perspective view of part of an exemplary embodiment of a cleaning set according to the invention, this time with two fastening pins (on the base plate) and a flexible, elongated piece of material as the first quick-release fastener element,

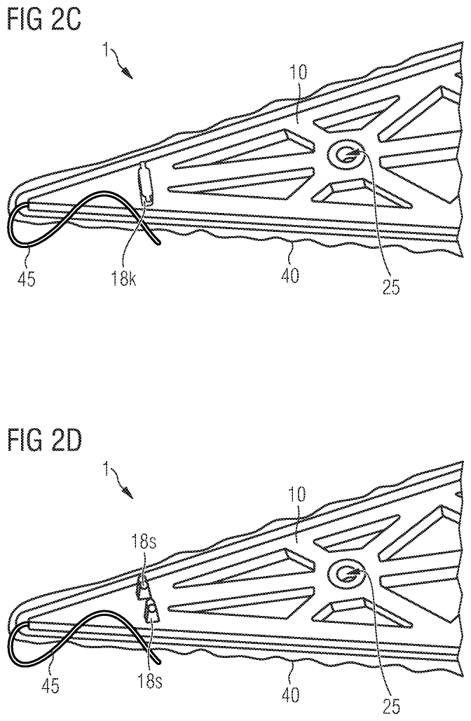

FIG. 3 is a perspective view of the underside of the exemplary embodiment from FIG. 1 (without textile mop cover),

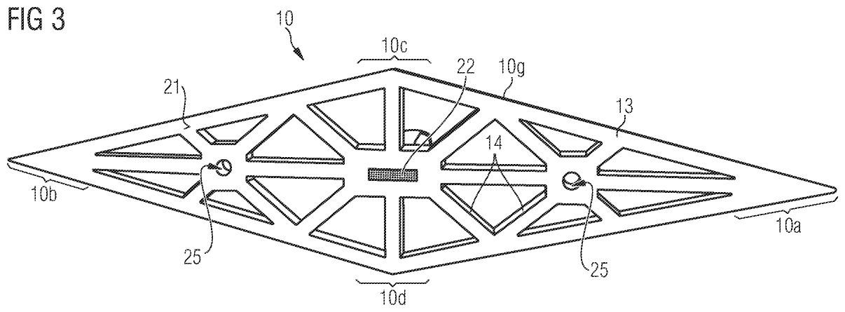

FIG. 4 is a perspective view of the upper side of a part of an exemplary embodiment of a cleaning set according to the invention (also without textile mop cover), this time with a differently configured adapter,

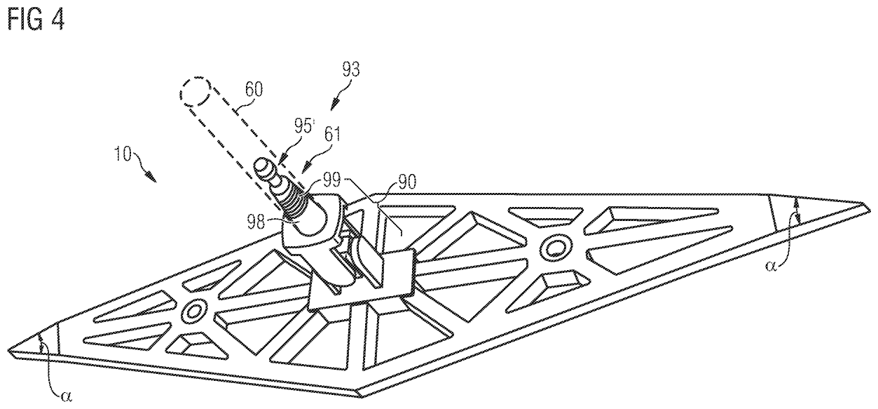

FIG. 5 is an exploded perspective view of a further exemplary embodiment of a cleaning set according to the invention, in a variation without a textile mop cover, but with a brush plate screwed to the underside of the base plate,

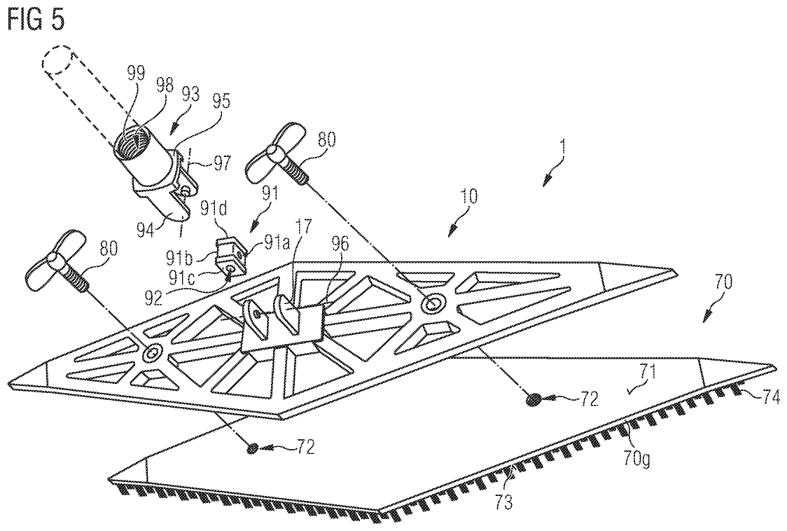

FIG. 6 is an additional exploded view of a further exemplary embodiment of a cleaning set according to the invention, this time with a retaining plate screwed to the underside of the base plate and a textile mop cover that can be attached to the underside of the retaining plate,

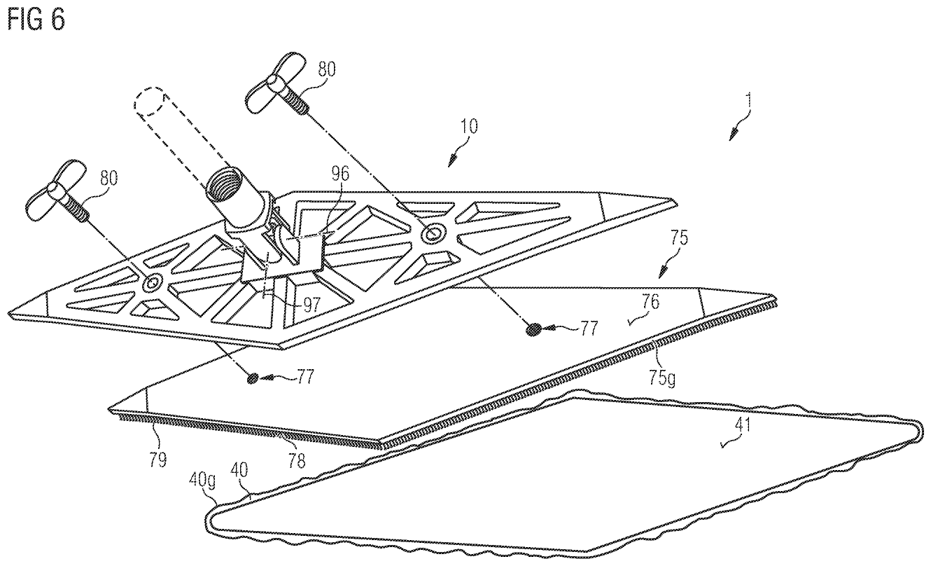

FIG. 7 is an exploded perspective view from below and to one side of a further exemplary embodiment of a cleaning set according to the invention with a handle on the upper side of the base plate and a textile mop cover for coupling to the underside of the base plate,

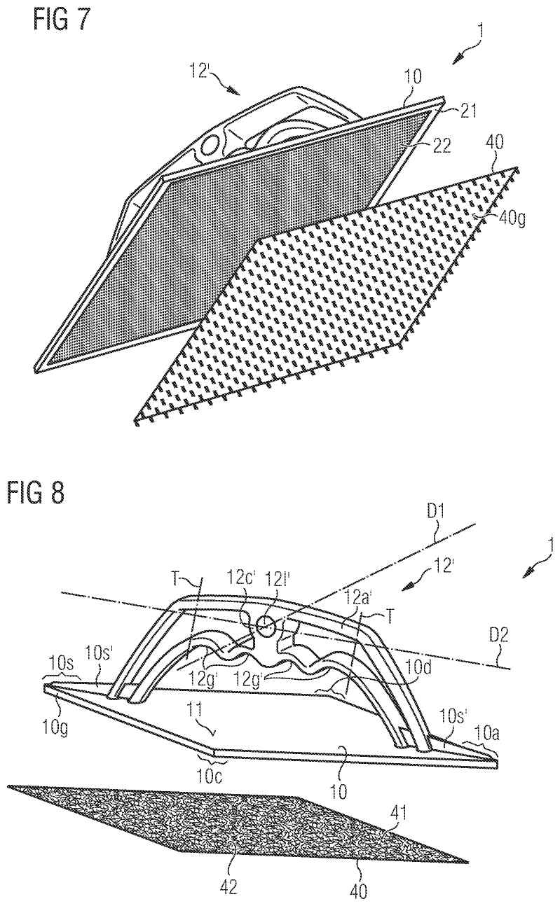

FIG. 8 is an exploded perspective view of the exemplary embodiment shown in FIG. 7 from above and to one side.

FIG. 1 shows an exemplary and diagrammatic perspective view of an upper side of an exemplary embodiment of a cleaning set 1 according to the invention.

The main components of this cleaning set 1 here include a base plate 10 with a diamond-shaped contour 10g, which has a coupling point 12 for an elongated shaft 60 or an end 61 of the shaft 60, the optional shaft 60 itself and a textile mop cover 40 with a textile base surface 40g that is also diamond-shaped and adapted in shape to the base plate 10.

The base plate 10 is further constructed from a diamond-shaped outer frame 13, between which a lattice structure 14 or lattice struts 14 run. The lattice struts 14 are evenly distributed so that they stabilise the structure uniformly. The diamond-shaped contour 10g of the base plate 10, or more precisely the outer frame 13, comprises two acute-angled corner regions 10a, 10b with an internal angle α (FIG. 4) as well as two obtuse-angled corner regions 10c, 10d (FIG. 3) between them, which are naturally opposite each other due to the diamond shape. The respective acute-angled corner regions 10a, 10b are connected and stiffened by a lattice strut in the longitudinal direction 55L along a long diagonal 57 and the respective obtuse-angled corner regions 10c, 10d are connected and stiffened by a lattice strut in the transverse direction 55Q along a short diagonal 56. VoidsVoids are left between the lattice struts 14, so that the construction requires considerably less material and, above all, saves weight compared with a base plate made of solid material. In addition, the lattice struts 14 themselves are hollow, which saves even more material and weight.

In addition to the two diagonal lattice struts 14, further lattice struts 14 extend obliquely (at approximately 45° angles) to the two diagonals 56, 57 within the outer frame 13. The obliquely extending lattice struts 14 each terminate at three points at 45° angles in the two diagonals 56, 57. At a central point, which forms the diagonal intersection 58, a reinforced central surface 12a is thereby created for the coupling point 12. At the other two off-centre points approximately half way between the diagonal intersection point 58 and the respective tip of the respective acute-angled corner regions 10a, 10b of the base plate 10, a reinforced attachment surface 15a, 15b is formed thereby. The inclined lattice struts 14 extend outwards into the outer frame 13 between the diagonals 56, 57 and the outer frame 13. As mentioned, the lattice-like construction or the lattice structure 14 thus economises on material and weight and is also extremely stable.

It should be mentioned at this point that the textile mop cover 40, which is explained in more detail below, also has two acute-angled corner regions 40a, 40b with an internal angle β and two obtuse-angled corner regions 40c, 40d to match the shape or contour 10g of the base plate 10, i.e. its textile base surface 40g is adapted to the base plate 10. An internal angle β can preferably be substantially identical to the aforementioned internal angle α of the acute-angled corner regions 10a, 10b of the base plate 10, possibly minimally, i.e. a few degrees larger.

The base plate 10 also comprises an upper side 11, on which the aforementioned coupling point 12 for the shaft 60, or more precisely the relevant end 61 of the shaft 60 (near the ground when in use) is located. An articulated coupling mechanism 90 is located at the coupling point 12 (see FIG. 4). Part of the coupling mechanism 90 here is a fork joint 17 on the base plate 10. This protrudes vertically upwards from the base plate 10 on the upper side 11 and forms a first fork joint axis 96 or longitudinal axis of rotation 96 with its two parallel “fork prongs” or limbs, which are spaced apart in the longitudinal direction 55L and which each have a pin (see FIG. 5). Between the limbs, it accommodates a joint block 91, which is equipped with a round bore 92 or a receiving hole 92 in two lateral surfaces 91a, 91b facing the limbs of the fork joint 17. In the coupled state (for decoupled, again see FIG. 5), a pin formed on the inside of the respective limb of the fork joint 17 is rotatably mounted in these holes. This allows the base plate 10 to be rotated about the first fork joint axis 96 with the fork joint 17. On two further side faces 91c, 91d of the joint block 91 in the transverse direction 55Q of the base plate 10, the latter has in each case a further receiving hole 92 for a further fork joint 94 on an adapter 93, which in turn has a pin on the inside of each of the limbs. This allows the second fork joint 94 to be rotated with the adapter 93 about a second fork joint axis 97 or transverse rotational axis 97. In total, the coupling mechanism 90 thus represents a two-axis joint or double joint and thus allows the shaft 60 to be swivelled relative to the base plate 10 over an entire “hemispherical surface”. This means that the base plate 10 is mounted on the shaft 60 or at the end 61 of the shaft 60 so that it can be moved across the floor in any wiping motion in order to clean a floor.

For coupling with one end 61 of the shaft 60, the adapter 93 in turn has an adapter element 95 on a side facing away from the fork joint 94, which can be configured for a respective type of shaft. In FIGS. 1 and 5, the adapter element 95 comprises a sleeve with a simple internal thread for solid material shafts or shafts 60 with a matching external thread at the end 61. These are mainly found in the American regions. FIG. 4 shows an alternative variation of the adapter element 95′, in which it has a tapered fitting section 98 and a tapered threaded section 99. These allow coupling with hollow shafts or shafts 60 that do not have an extra external thread at the end 61. Such shafts are particularly common in Europe.

The textile mop cover 40 is arranged on the back of the upper side 11, i.e. on an underside 21 of the base plate 10, and is releasably attached when in use.

To ensure that the textile mop cover 40 also adheres securely to the underside 21 of the base plate 10 during use—i.e., for example, during lateral wiping movements and when lifting slightly, e.g. to mop the next step or the next room behind a threshold—the base plate 10 has a hook strip 22 as an adhesive element 22, preferably a hook-and-loop element 22, in at least a central area (FIG. 3). In turn, the textile mop cover 40 adheres to this hook strip 22 with a fleece strip 42 as a mating adhesive element 42, preferably a mating hook-and-loop element 42 (FIG. 1). This very simple solution already ensures a secure hold between the base plate 10 and the textile mop cover 40. Alternatively, a material that adheres to the hook strip 22 could also be selected for the textile mop cover 40 (at least on the upper side 41 or inner side 41). The same material can be used for the underside 51 of the textile mop cover 40, i.e. the side of the textile mop cover 40 that comes into contact with the floor to be cleaned during use, provided that it is suitable as a cleaning material for the floor.

For an even more solid, better hold, the textile mop cover 40 in FIG. 1 additionally comprises an insertion pocket 43 at a first acute-angled corner region 40a of the textile base surface 40g on an upper side 41 or inner side 41. This consists of an substantially triangular section of material which is sewn to the textile mop cover 40 in the first acute-angled corner region 40a, forming a “pocket”, so that the first acute-angled corner region 10a of the base plate 10 can be inserted or threaded into it. This then ensures that the textile mop cover 40 is also held particularly securely in position on the base plate 10 in this corner region 10a.

In addition, at a second acute-angled corner region 40b of the textile base surface 40g opposite the first acute-angled corner region 40a, the textile mop cover 40 comprises a first quick-release fastener element 45, here in the form of an elongated, flexible piece of material 45, in particular in the form of a textile hook-and-loop tab 451, more specifically a fleece strip 451, which is permanently secured to a further hook strip 16 as a mating coupling element 16 of the base plate 10 on the upper side 11 of the base plate 10 (see FIG. 1). As can be seen from FIG. 2, the hook-and-loop tab 451, in the case shown the fleece strip 451, can be attached to the hook strip 16 of the base plate 10 very quickly, easily and simply in a fraction of a second and can be detached again just as quickly.

However, as an alternative variation to such a tab 451, in particular a hook-and-loop tab 451, the textile mop cover 40 can also simply have a flexible, elongated piece of material 45 in the form of a strip, cord, string or the like as the first quick-release fastener element 45 and be fastened with it, as shown in FIGS. 2C and 2D.

In addition, the base plate 10 can comprise a cleat 18k (see FIG. 2C) as the anchoring means 18k, 18s on the base plate 10. With a little practice and the right technique, the flexible, elongated piece of material 45 can then be wrapped or knotted in an effective manner around the “horns” of the cleat 18k which are directed away from each other in a short time, i.e. a few seconds, for example in the form of a horizontal “figure of eight” in the manner of a “Dopino” knot (i.e. starting with a slip knot with a half hitch at the end, the other way round to a normal cleat hitch).

More preferably, however, the anchoring means 18k, 18s can be in the form of two fastening pins 18s which are spaced apart from each other, as shown in FIG. 2D. These can preferably be configured to be slip-resistant or be provided with a slip-resistant coating, so that the flexible, elongated piece of material 45 does not slip and thus become loose when it is wrapped around it. As an example, they can have a rubber coating or alternatively a particularly rough coating. It is also conceivable for them to have a type of profile or thread that prevents the piece of material 45 from slipping. Alternatively, they can also have a type of “head” that prevents the piece of material 45 from slipping (indicated in FIG. 2D).

However, such a flexible, elongated piece of material 45 can also form a loop 45s with the textile mop cover 40, for example as shown here in FIG. 2B, sewn onto the respective contour edges 46 of the textile mop cover 40 enclosing the acute angle. The aforementioned loop 45s can specifically consist of an elastic band or elastic strip, for example, which enables the textile mop cover 40 to be quickly attached to a corner, e.g. the corner region 10b of the base plate 10.

Finally, in order to further improve the hold on the base plate 10, the textile mop cover 40 in FIG. 1 has an optional insertion strip 44. This runs between a short diagonal 56 and the insertion pocket 43, substantially parallel to the short diagonal 56 on the upper side 41 of the textile mop cover 40 (e.g. at the position shown here closer to the short diagonal 56, somewhat off-centre from the centre of the textile mop cover 40) and connects the two relevant contour edges 46 in the transverse direction 55Q in the form of a strip, with the formation of a loop, in order in turn to accommodate the associated acute-angled corner region 10a of the base plate 10. This insertion strip 44 is configured here to be inelastic, so that the textile mop cover 40 lies or remains as close as possible against the base plate 10.

In the two attachment surfaces 15a, 15b already mentioned above, two through-holes 25 are formed from the upper side 11 to the lower side 21 through the base plate 10 as parts of second quick-release fastener elements 25.

As can be seen in the exploded view according to FIG. 5 with the aid of a further exemplary embodiment of a cleaning set 1 according to the invention with a cleaning attachment 70, in a further variation, the cleaning attachment 70, here a brush plate 70, for example, can be attached to the underside of the base plate 10 in a very simple manner, e.g. by screwing, for example for cleaning a rougher floor covering. In this case, the brush plate 70 replaces the textile mop cover 40. Such a brush plate 70 is also suitable for particularly stubborn dirt, for example. The shape of the brush plate 70 is adapted to the base plate 10 and accordingly has a diamond-shaped base surface 70g and an upper side 71 with two internally threaded holes 72 and an underside 73 with bristles 74. The aforementioned through-holes 25 are thus used to attach the brush plate 70 to the base plate 10 with the aid of two matching screw elements 80, in this case wing screws 80, i.e. threaded rods with wing nuts, so to speak. However, the invention is not restricted to such wing screws alone. Other comparable screw means or cylindrical clamping or expanding means that can be clamped or expanded within the through holes are also possible.

The wing screws 80 are passed through the through-holes 25 for attachment from above, i.e. an upper side 11 of the base plate 10, and screwed into the internally threaded holes 72 on the upper side 71 of the brush plate 70. The base plate 10 and the shaft 60 thus enable convenient guidance and cleaning of the floor with the brush plate 70.

However, in addition to the exemplary brush plate 70 shown as a possible cleaning attachment 70, a selection of other cleaning attachments (not shown), such as a sponge element or a pad plate, can also be attached to the base plate 10 in the same or at least a similar manner.

According to a further exemplary embodiment of a cleaning set 1 according to the invention, a retaining plate 75 with a retaining element 79 is alternatively—as shown in FIG. 6—attached to an underside 78 of the retaining plate 75 for releasable coupling of the textile mop cover 40 to the base plate 10 in the same or at least a similar manner. The retaining plate 75, which has a diamond-shaped base surface 75g adapted to the diamond-shaped contour 10g of the base plate 10, represents an alternative solution for indirectly attaching the textile mop cover 40 to the base plate 10, as shown in FIG. 6.

The retaining plate 75 with retaining element 79, preferably retaining element 79, in particular the hook-and-loop element 79, is a plate which is very similar to the brush plate 70 shown in FIG. 5 except for the bristles 74 on the underside 73 of the brush plate 70.

In contrast to the brush plate 70, instead of bristles 74 for cleaning the floor, the retaining plate 75 has a retaining element 79 for releasable coupling of the textile mop cover 40 substantially on the entire underside 78, so that the textile mop cover 40 can be attached to the retaining element 79 very quickly for cleaning a floor and can also be detached again just as quickly. In this respect, this could also be referred to as an adhesive plate 75. In this example, the retaining element 79 comprises an adhesive coating in the form of a plurality of small hooks, to which the material of the textile mop cover 40 adheres excellently if the right material is selected. These can be integrated into the retaining plate 75, preferably by injection moulding. This has the advantage that the base plate 10 could then basically do without a mating coupling element for the first quick-release fastener element and could only function as a “base plate”. Furthermore, when such a retaining plate 75 is used, a textile mop cover 40 can be provided without insertion pockets or without a first quick-release fastener element.

In order to further improve the hold of the textile mop cover 40 on the hooks of the retaining element 79, an upper side 41 of the textile mop cover 40, i.e. a side of the textile cover 40 facing the retaining element 79 in the coupled state, can be provided with at least one, preferably several fleece strips, in particular over the entire surface with a fleece surface as a mating adhesive element.

For cleaning with the retaining plate 75, this is screwed to the base plate 10. Here too, the wing screws 80 for attachment are guided from above, i.e. an upper side 11 of the base plate 10, through the through-holes 25 and screwed into suitable internal threaded holes 77 on an upper side 76 of the retaining plate 75. A textile mop cover 40 is then attached to the underside 78 of the retaining plate 75. This is then used to clean until it is soiled to a certain degree or a certain floor area has been cleaned. Then, in a very short time, the textile mop cover 40 can simply be pulled off the adhesive element 79 of the retaining plate 75 with one hand and a new, fresh textile mop cover 40 can be pulled on or attached.

FIGS. 7 and 8 show a further exemplary embodiment of a cleaning set 1 according to the invention with a hand grip 12′ on the upper side 11 of the base plate 10.

The base plate 10 again has a diamond-shaped contour 10g with two acute-angled corner regions 10a, 10b opposite each other at the ends of a longer first diagonal of the diamond and two obtuse-angled corner regions 10c, 10d (FIG. 8) opposite each other at the ends of a shorter diagonal extending perpendicular to the first diagonal. As in the other embodiments, the base plate 10 is mirror-symmetrical with respect to both diagonals.

The internal angle of the acute-angled corner regions 10a, 10b is preferably at most 70°, more preferably at most 60° and/or preferably at least 35°, more preferably at least 40°; most preferably, it is approx. 50°.

The internal angle of the obtuse-angled corner regions 10c, 10d is preferably at least 115°, more preferably at least 120° and/or preferably at most 145°, more preferably at most 140°; most preferably, it is approx. 130°.

Since such a cleaning set 1 with a hand grip 12′ can also be used for manual cleaning in particular, it is also possible to manufacture a smaller version.

The length of the first diagonal is therefore preferably at most 35 cm, more preferably at most 30 cm and/or preferably at least 20 cm, more preferably at least 25 cm. Most preferably, this length is approx. 26 cm.

For a given length of the first diagonal and given internal angles in the corner regions, the length of the second diagonal is already clearly defined.

However, the dimensions can be such that the length of the second diagonal is preferably at most 15.5 cm, more preferably at most 15 cm and/or preferably at least 13 cm, more preferably at least 14 cm. This length is most preferably approx. 14.5 cm.

The hand grip 12′ is arranged on the upper side 11 of the base plate 10 in a manner such that a longitudinal direction of the hand grip 12′ runs along the first diagonal from one of the acute-angled corner regions 10a, 10b to the other.

The hand grip 12′ is constructed in a kind of lattice design with two struts 12a′, 12b′ extending one above the other in the longitudinal direction of the hand grip 12′, substantially in an arch from the first acute-angled corner region 10a to the second acute-angled corner region 10b of the base plate 10, namely an upper arc strut 12a′ (or upper strut 12a′) and a handle strut 12b′ (or lower strut 12b′) extending below it. At the apex, the handle strut 12b′ is connected to the arcuate strut 12a′ above it via a cross strut 12c′ (extending substantially vertically relative to the surface of the base plate 10). To the right and left of the cross strut 12c′, there are two voids 12h′ in the hand grip 12′ between the arcuate strut 12a′ and the handle strut 12b′.

A coupling eyelet 12l′ extends through the cross strut 12c′ itself between the handle strut 12b′ and the arcuate strut 12a′, which can be used for coupling to a suitable adapter on a shaft. The coupling eyelet 12l′ is formed here by a simple coupling hole or coupling bore 12l′, the axis of which runs transversely to the longitudinal extent of the hand grip 12′ and parallel to the second, shorter diagonal of the base plate 10. As an example, an adapter as described in DE 10 2019 113 870 A1 or the adapter element 95 shown above in connection with FIG. 5 can be coupled directly into this coupling eyelet 12l′. The axis of the coupling eyelet 12l′ then forms a first swivel axis D1 about which the shaft can be swivelled relative to the base plate 10. However, as already described, it is also possible here to use a joint mechanism in an adapter, for example, which allows swivelling with several degrees of freedom.

Thus, the hand grip 12′ itself forms a suitable coupling point 12′ for a sss.

The handle strut 12b′ is configured and arranged in a manner such that a sufficiently large grip eyelet 120′ remains between the upper side 11 of the base plate 10 and the handle strut 12b′, into which a user can easily reach with four fingers of their hand. In addition, the grip strut 12b′ is shaped in a manner such that it has several (here specifically four) recessed hand grips 12g′ in order to comfortably place the four fingers on the grip strut 12b′.

The arcuate strut 12a′ extending above the handle strut 12b′ is also shaped in a manner such that it allows the hand grip 12′ to be gripped as ergonomically as possible. In the present case, the arcuate strut 12a′ has an elongated upper section that is only slightly curved in the uppermost area and two steeper end sections that run at an obtuse angle to the top of the base plate 10. These end sections are also only slightly curved.

For better stabilisation of the hand grip 12′ on the base plate 10 and for stabilisation of the pointed corners of the base plate 10, a reinforcing web 10s′ respectively extends in the end regions of the longer, first diagonal on the upper side 11 of the base plate 10 between the handle strut 12b′ and the arcuate strut 12a′ and beyond these into the pointed corner. This reinforcing web 10s′ is shaped in a manner such that it steadily becomes thinner and lower towards the tip of the base plate 10.

The entire hand grip 12′ with all the struts 12a′, 12b′, 12c′ and the reinforcing webs 10s′ is configured in a manner such that it is particularly ergonomically shaped and allows the user to work as gently as possible without tiring. In addition, on the one hand it is relatively light due to the lattice design and requires relatively little material and, on the other hand, it is extremely stable on the base plate 10. It is preferably manufactured in one piece with the base plate 10 (more preferably in an injection moulding process).

FIG. 8 schematically shows another possible variation which allows a shaft to be coupled to the base plate on a hand grip 12′ so that it can be swivelled about two swivel axes D1, D2. The first swivel axis D2 is defined by the axis of the coupling eyelet 12l′. However, the hand grip 12′ would then additionally be divided into three sections, for example at the dividing lines T shown in dashed lines. In this case, the hand grip 12′, unlike that shown in FIG. 8, would preferably not be manufactured in a lattice construction, but the region between the handle strut 12b′ and the arcuate strut 12a′ could be completely filled in, i.e. the hand grip 12′ would then have a single wide curve (preferably with the recessed hand grips 12g′ on the underside facing the base plate 10), for example. Alternatively, the handle strut 12b′ and the arcuate strut 12a′ could have further cross struts to the right and left of the dividing lines. In the region of these dividing lines T, the centre section of the hand grip 12′ arranged between the dividing lines T is then pivotable about a second swivel axis D2 with the two outer sections of the handle, which are securely connected to the upper side 11 of the base plate 10, so that a shaft coupled to the coupling eyelet 12l′ is coupled here to the base plate 10 so as to be pivotable about two swivel axes D1, D2 extending perpendicular to each other.

Interacting latching means, locking means or the like can also be located at the respective separating lines T on the centre section and on the outer sections of the hand grip 12′ in order to fix or latch the centre section of the hand grip 12′ in a basic position in which the swivel axis D1 runs through the coupling eyelet 12l′ parallel to the upper side 11 of the base plate 10 (i.e. in the position of the coupling eyelet 12l′ shown in FIG. 8), wherein the centre part can then be swivelled out of this basic position with a little additional force.

On the underside 21 of the base plate 10 there is again an adhesive element 22 in the form of a hook-and-loop element 22, but this extends over the entire surface of the underside 21, apart from a thin peripheral edge region. In principle, however, the adhesive element 22 could also extend completely over the underside 21. Here too, the adhesive element 22 or hook-and-loop element 22 can be configured in the form of a type of hook surface or the like with a plurality of (small) hooks, spikes, etc., to which the material of the textile mop cover 40 adheres superbly if the appropriate material is selected. More preferably, these hooks, spikes etc. can also be integrated into or formed on the underside 21 of the base plate 10 during manufacture of the base plate 10, in particular by injection moulding.

In use, the textile mop cover 40 (shown separately in FIGS. 7 and 8) is arranged on the back of the upper side 11, i.e. on an underside 21 of the base plate 10, and is releasably attached.

This textile mop cover 40 is again configured to match the shape or contour 10g of the base plate 10, i.e. its textile base surface is adapted to the base plate 10.

Here, the entire surface of the upper side 41 of the textile mop cover 40, i.e. the side of the textile cover 40 facing the adhesive element 22 in the coupled state, is preferably provided with a fleece surface or the like as a mating adhesive element.

Particularly suitable materials for the textile mop cover 40 (for the production of a suitable adhesive upper side 41 facing the adhesive element 22 as well as an underside which is particularly suitable for cleaning) can be selected in each case as described above in general or also for the other exemplary embodiments.

Although the quick and easy replacement of a dirty textile mop cover with a fresh, washed textile mop cover is considerably more important in commercial cleaning than is the case in private use, since there the textile mop cover is usually washed out, wrung out and then reused several times, the invention can of course also be advantageous for private use. In particular, because frequent washing and wringing out can also be very tiring and stressful for the hands in the long term. Not to mention the fact that such a procedure with several fresh textile mop covers, which are only washed together in a hot wash in the washing machine after the floor has been cleaned, would also be more hygienic at home.

Finally, it should be pointed out once again that the devices described in detail above are merely examples of embodiments which can be modified by the skilled person in a wide variety of ways without departing from the scope of the invention. As an example, coupling elements for coupling the cleaning attachments to the base plate other than the screw elements mentioned, such as universal closures with an integrated bottle opener, such as those known for closing glass bottles, in particular wine bottles, quick-release levers, etc., also fall within the scope of the invention. It is true that the cleaning set is particularly suitable for cleaning a floor. In principle, however, it can also be used to clean a wall, table or ceiling surface. In particular, it is also suitable for wiping, applying a cleaning fluid and for disinfecting a wall, table or ceiling surface. Furthermore, the use of the indefinite articles “a” or “an” does not exclude the possibility that the features in question may also be present more than once. Likewise, the term “element” does not exclude the possibility that the component in question consists of several interacting sub-components, which may also be distributed in space.

### LIST OF REFERENCE SYMBOLS

1 cleaning set
10 base plate
10g contour
10a first acute-angled corner region of the base plate
10b second acute-angled corner region of the base plate
10c, 10d obtuse-angled corner regions of the base plate
10s′ reinforcement web
11 upper side of the base plate
12 coupling point
12′ coupling point/handle
12a central area for the coupling point
12a′ Arcuate strut/upper strut
12b′ handle strut/lower strut
12c′ cross strut
12g′ recessed hand grip
12h′ void
12l′ coupling hole
13 diamond-shaped outer frame of the base plate
14 inner lattice structure/lattice struts of the base plate
15a, 15b attachment surface around the off-centre through-holes
16 mating coupling element/hook strip of the base plate
17 fork joint of the base plate
18k anchoring means/cleat
18s anchoring means/fastening pins
21 underside of the base plate
22 adhesive element/hook-and-loop element/hook strip
25 second quick-release fastener element/through-hole
40 textile mop cover
40g textile base area of the textile mop cover
40a first acute-angled corner region of the textile mop cover
40b second acute-angled corner region of the textile mop cover
40c, 40d obtuse-angled corner regions of the textile mop cover
41 upper side/inside of the textile mop cover
42 mating adhesive element/mating hook-and-loop element/loop strips
43 Insertion pocket
44 Insertion tape
45 first quick-release fastener element/material part of the textile mop cover
45l first quick-release fastener element/flap/textile flap/hook-and-loop flap
45s first quick-release fastener element/loop
46 contour edges of the textile mop cover
51 underside/outside of the textile mop cover
55L longitudinal direction of the textile base surface or base plate
55Q transverse direction of the textile base surface or base plate
56 short diagonal of the diamond-shaped textile base surface or base plate
57 long diagonal of the diamond-shaped textile base surface or base plate
58 diagonal intersection
60 shaft
61 end of the handle
70 cleaning attachment/brush plate
70g plate-like, diamond-shaped base surface of the brush plate
71 upper side of the brush plate
72 internal threaded holes
73 underside of the brush plate
74 bristles
75 retaining plate
75g base area of the retaining plate
76 upper side of the retaining plate
77 internal threaded holes of the retaining plate
78 underside of the retaining plate
79 retaining element/adhesive element/hook-and-loop element
80 second quick-release fastener element/coupling element/screw element
90 coupling mechanism
91 joint blocks
91a, 91b, 91c, 91d lateral surfaces
92 holes/mounting holes
93 adapter
94 fork joint of the adapter
95 adapter element
96 first fork joint axis/longitudinal rotational axis/first degree of freedom
97 second fork joint axis/transverse rotational axis/second degree of freedom
98 tapered fitting section
99 tapered threaded section
D1 first swivel axis
D2 second swivel axis
T dividing line
α internal angle of the acute-angled corner regions of the base plate
β internal angle of the acute-angled corner regions of the textile base surface

1. A cleaning set (1) for cleaning a surface, preferably a floor, comprising at least
a base plate (10) with an upper side (11), on which a coupling point (12, 12′) for a shaft (60) is arranged, and with an underside (21) facing away from the upper side (11), wherein the base plate (10) has a diamond-shaped contour (10g), and
a textile mop cover (40) with a diamond-shaped textile base surface (40g), which is adapted to the diamond-shaped contour (10g) of the base plate (10), and/or a further cleaning attachment (70) which can be coupled to the underside (21) of the base plate (10),
wherein on the underside (21), the base plate (10) comprises at least one adhesive element (22), preferably a hook-and-loop element (22), and preferably the textile mop cover (40) comprises at least one matching mating adhesive element (42), preferably a mating hook-and-loop element (42), on an upper side (41),
and/or
wherein the textile mop cover (40)
has an insertion loop and/or insertion pocket (43) for a first acute-angled corner region (10a) of the base plate (10) on at least a first acute-angled corner region (40a) of the diamond-shaped textile base surface (40g) on an upper side (41) and
has a first quick-release fastener element (45, 451, 45s) or a second insertion pocket (43) for releasable coupling to the base plate (10) on at least one second corner region (40b, 40c, 40d), preferably a second acute-angled corner region (40b), of the diamond-shaped textile base surface (40g), which is preferably opposite the first acute-angled corner region (40a) of the textile base surface (40g),
and/or
wherein the base plate (10) is associated with a retaining plate (75) which can be releasably coupled to the underside (21), wherein the retaining plate (75) has at least one retaining element (79) for releasably coupling the textile mop cover (40).

2. The cleaning set according to claim 1, wherein the first quick-release fastener element (45, 45l, 45s) comprises a flexible, elongated piece of material (45, 45l, 45s), and preferably the base plate (10) has anchoring means (18k, 18s) for the flexible, elongated piece of material (45) on its upper side (11).

3. The cleaning set according to claim 2, wherein the base plate (10) comprises a cleat (18k), preferably two spaced-apart fastening pins (18s), on its upper side (11) as anchoring means (18k, 18s) for the flexible, elongated piece of material (45).

4. The cleaning set according to claim 1, wherein the first quick-release fastener element (45, 45l, 45s) comprises a tab (451), preferably a hook-and-loop tab (45l) for a mating hook-and-loop element (16) arranged on the upper side (11) of the base plate (10),
wherein the mating hook-and-loop element (16) is more preferably arranged at the top in the region of a second acute-angled corner region (10b) of the base plate (10).

5. The cleaning set according to claim 1,
wherein the first quick-release fastener element (45) comprises an elongated elastically extendable loop (45s), which can at least be slipped over one acute-angled corner region (10b) of the base plate (10) for attachment to the base plate (10),
and/or,
wherein the textile mop cover (40) is provided with an insertion strip (44) on a side half having the insertion loop and/or insertion pocket (43), which internally connects the two contour edges connected by the insertion loop and/or insertion pocket (43) in the first acute-angled corner region (40a) of the diamond-shaped textile base surface (40g) at a position between the insertion loop and/or insertion pocket (43) and a short diagonal (56) of the diamond-shaped textile base surface (40g).

6. The cleaning set according to claim 1, wherein the further cleaning attachment (70) and/or the retaining plate (75) can be releasably coupled to the base plate (10) by means of at least one second quick-release fastener element (25),
wherein the cleaning attachment (70) and/or the retaining plate (75) preferably have a plate-like, diamond-shaped base surface (70g, 75g), which is adapted to the diamond-shaped contour (10g) of the base plate (10).

7. The cleaning set according to claim 1, wherein the further cleaning attachment (70) comprises at least one of the following elements:
a brush plate (70),
a sponge element,
a pad plate.

8. The cleaning set according to claim 6, wherein the second quick-release fastener element (25) on the base plate (10) has at least one, preferably two, through-holes (25) passing through the base plate (10), and comprises at least one coupling element (80), preferably a screw element (80), in order to couple the further cleaning attachment (70) and/or the retaining plate (75) to the underside of the base plate (10) through the through-holes (25).

9. The cleaning set according to claim 1, wherein the retaining element (79) of the retaining plate (75) has an adhesive element (79), in particular a hook-and-loop element (79), and/or wherein at least 30%, preferably at least 50%, preferably at least 75%, of an underside (78) of a base surface (75g) of the retaining plate (75) has a retaining element (79).

10. The cleaning set according to claim 1, comprising a hand grip (12′) arranged on an upper side (11).

11. The cleaning set according to claim 1, comprising a coupling mechanism (90) arranged at the coupling point (12) of the base plate (10), which connects the base plate (10) to the shaft (60),
wherein the coupling mechanism (90) is configured such that the shaft (60) is pivotable relative to the base plate (10) with at least two degrees of freedom (96, 97),
wherein the cleaning set (1) preferably comprises a fork joint (17) on the base plate (10), a joint block (91) rotatable in this fork joint (17) about a first fork joint axis (96) with fork joint receiving holes (92) in at least two of its lateral surfaces (91a, 91b, 91c, 91d), as well as an adapter (93) which can be coupled to the joint block (91) by means of a further fork joint (94) and has an interface for a shaft (60), which adapter (93) can be rotated about a second fork joint axis (97) in the further fork joint (94).

12. The cleaning set according to claim 1, with a shaft (60) as a handle and extension for a user to hold and guide the cleaning set (1) and preferably an adapter (93) for attaching the base plate (10) to the shaft (60) with an adapter element (95) which has
a tapered fitting portion (98) for forming a positive locking fit with one end (61) of the shaft (60), and
a tapered threaded section (99).

13. The cleaning set according to claim 1, wherein the underside (21) of the base plate (10) is flat in configuration over the entire contour (10g).

14. The cleaning set according to claim 1, wherein the base plate (10) comprises a peripheral diamond-shaped outer frame (13), between which an inner lattice structure (14) with lattice struts (14) extends for stabilisation and stiffening.

15. The cleaning set according to claim 14, wherein the lattice structure (14) is configured in a manner such that the lattice struts (14) converge in a star shape at three positions on one of the diagonals (56, 57),
wherein at a central position of the three positions, they form an overlapping central surface (12a), at which the coupling point (12) for a shaft (60) is located, and at the two off-centre positions, they each form an overlapping attachment surface (15a, 15b), into each of which the through holes (25) are made,
wherein preferably, the lattice struts (14) of the lattice structure (14) each protrude from the outer frame (13) at the same angle,
wherein more preferably, the lattice struts (14) are hollow on the inside.
